(19) United States
(12) Patent Application Publication
(10) Pub. No.: US 2020/0361830 A1
(43) Pub. Date: Nov. 19, 2020

(54) IRON FERTILIZER FOR LAWN GREENING AND TONING

(71) Applicant: Allen Pyle, Green Bay, WI (US)

(72) Inventor: Allen Pyle, Green Bay, WI (US)

(21) Appl. No.: 15/931,005

(22) Filed: May 13, 2020

Related U.S. Application Data
(60) Provisional application No. 62/847,588, filed on May 14, 2019.

(51) Int. Cl. C05D 3/00; C05D 9/02; C05G 5/12; C05G 5/30; C05F 11/02; C05C 9/00

(52) U.S. Cl. CPC C05D 3/00; C05D 9/02; C05G 5/12; C05G 1/00; C05F 11/02; C05C 9/005; C05G 5/37

(57) ABSTRACT

A fertilizer that is suitable for use all year long that is comprised of extruded or agglomerated pellets having fertilizer and iron, and further comprised of gypsum, seaweed, seaweed extract, humic substances, or a combination of same.

### RELATED APPLICATIONS

The application claims priority to provisional application 62/847,588 filed May 14, 2019.

### FIELD OF THE INVENTION

The present invention relates to the use of a fertilizer that comprises iron for lawn greening and toning.

### BACKGROUND OF THE INVENTION

Summer can produce stressful conditions for lawns, due to high temperatures and moisture stress. In addition to slowing growth, stressed lawn grasses are more susceptible to insect and disease problems.

Applying fertilizers high in nitrogen is not recommended during summer conditions, as they are often not utilized efficiently by lawn grasses, particularly if they are stressed. There is a high likelihood that a significant amount of the fertilizer will be lost in runoff or leaching through the soil, which can have negative environmental impacts.

U.S. Pat. No. 5,698,001 relates to chelated iron, which is a technique to make this nutrient more available to plants and reduce its potential loss from soils. Humic substances have a similar effect due to the very high cation exchange capacity. This is not due to formulating specific iron compounds.

### SUMMARY OF THE INVENTION

The present invention relates to a fertilizer that is suitable for use all year, including summer, to promote greening of lawn grasses without strongly stimulating leaf growth. It is an object of the present invention for the fertilizer to help tone the lawn grass, making it more resistant to environmental stresses.

The present invention relates to a fertilizer that comprises extruded or agglomerated pellets containing iron, gypsum, seaweed, seaweed extract, humic substances, or a combination thereof.

It is an object of the present invention for the seaweed and seaweed extracts to be used at low concentrations to improve plant growth. There are numerous types of seaweeds, and they are grouped into classes based on their color. Thus, there are types of green, brown and red seaweeds. In a preferred formulation, brown seaweed is used. It is an object of the present invention to use green seaweed.

Research has shown seaweed to stimulate root growth, improve plant resistance to environmental stresses (including drought and heat), and increase plant pigment levels, including chlorophyll. It is thought that increased chlorophyll content produced from seaweed treatment is due to improved longevity of chlorophyll. Chlorophyll is the engine in plants that converts sunlight into sugar for energy in plants.

Seaweed extract has been shown to be effective at very low application rates. In agronomic crops, generally 1 to 1.5 pounds of seaweed extract is applied per acre. This is usually done by dissolving the seaweed in a large volume of water and using spray equipment to apply it. In a homeowner setting, this application rate is approximately 10 to 15 grams of seaweed per thousand square feet.

It can be difficult for homeowners to accurately apply such a low rate of seaweed, even using a liquid spray. Incorporating seaweed extract into granules applied with standard spreading equipment simplifies application of products containing seaweed.

Humic substances (humic acids, fulvic acids, humins) have beneficial effects on plants at low levels, Promotion of root growth is a primary factor of interest, as it helps to promote water and nutrient uptake. In addition, humic substances promote the conversion of certain elements, including phosphorous, into forms that can be utilized by plants, thereby improving nutrient availability.

It is an object of the present invention for the fertilizer to be blended with a small amount of slow-release nitrogen (approximately 0.5 to about 2% of total weight) and with additional pelletized gypsum. It is an object of the present invention for the slow-release nitrogen to be from an organic source, inorganic source, or a combination. It is an object of the present invention for the gypsum to be treated with an anionic, water soluble polyacrylamide (WSPAM). It is an object of the present invention for seaweed and/or humic substances to be included in an iron-gypsum pellet to produce a homogeneous pellet. It is an object of the present invention for the seaweed and/or humic substances to be pelleted alone or together and blended into the fertilizer.

It is an object of the present invention for the seaweed or seaweed extract to be added at approximately 0.25% to about 2% of the total product weight. This rate is sufficient to produce these positive effects. It is an object of the present invention for the humic substances to be added at approximately 0.25% to about 10% of total product weight.

It is an object of the present invention to provide a pellet or granule that comprises iron, gypsum and fertilizer to eliminate the need to bulk blend fertilizer.

It is an object of the present invention to provide a pellet or granule that comprises iron, gypsum and seaweed extract to provide significantly improved drought tolerance and stress tolerance.

### DETAILED DESCRIPTION OF THE INVENTION

An iron fertilizer was produced with the following components:
1. Magnetite and Gypsum were processed into a particulate form for agglomeration.
2. The Magnetite particles and Gypsum particles were mixed with 1% seaweed extract by weight and agglomerated with a pressure extrusion agglomeration system.
3. The resulting agglomerates are dried to the desired moisture content.
4. The agglomerates are then screened to the desired particle size.
5. Screened agglomerates are sprayed with an oil emulsion of WSPAM, applying 1% WSPAM of total product weight.
6. The WSPAM is allowed to dry.
7. The agglomerates are bulk blended with polymer coated urea (PCU) at 0.5% by weight of PCU.

1. A fertilizer that is suitable for use all year comprising:
extruded or agglomerated pellets having fertilizer and iron, and further comprising gypsum, seaweed, seaweed extract, humic substances, or a combination thereof;
said fertilizer promoting greening of lawn grasses without strongly stimulating leaf growth;
said fertilizer toning said lawn grass, making it more resistant to environmental stresses.

2. The fertilizer of claim 1 wherein said seaweed comprises brown seaweed.

3. The fertilizer of claim 1 wherein said seaweed comprises green seaweed.

4. The fertilizer of claim 1 wherein said fertilizer is blended with approximately 0.5% to about 2% slow-release nitrogen.

5. The fertilizer of claim 4 wherein said slow-release nitrogen is from an organic source, inorganic source or a combination.

6. The fertilizer of claim 1 wherein said gypsum is treated with an anionic, water soluble polyacrylamide (WSPAM).

7. The fertilizer of claim 1 wherein said seaweed or humic substances are included in iron gypsum pellets to produce a homogeneous pellet.

8. The fertilizer of claim 1 wherein said seaweed or humic substances are blended into said fertilizer.

9. The fertilizer of claim 1 wherein said seaweed or seaweed extract is added to said fertilizer at approximately 0.25% to about 2% of total product weight.

10. The fertilizer of claim 1 wherein said humic substances are added at approximately 0.25% to about 10% of total product weight.

11. A fertilizer pellet or granule comprising:
iron, gypsum and fertilizer.

12. The fertilizer pellet or granule of claim 11 further comprising:
seaweed extract.

13. A method of producing a fertilizer containing iron comprising:
processing magnetite and gypsum into magnetite particles and gypsum particles for agglomeration;
agglomerating said magnetite particles and said gypsum particles with approximately 1% seaweed extract by weight to form agglomerates;
drying said agglomerates;
screening said agglomerates;
spraying said agglomerates with an oil emulsion of WSPAM;
drying said agglomerates;
bulk blending said agglomerates with polymer coated urea.

14. The method of claim 13 wherein said WSPAM is applied at 1% of total product weight.

15. The method of claim 13 wherein said polymer coated urea is 0.5% by weight.
